(19) United States
(12) Patent Application Publication
(10) Pub. No.: US 2021/0382199 A1
(43) Pub. Date: Dec. 9, 2021

(54) Model Featuring N-Porosity

(71) Applicant: Saudi Arabian Oil Company, Dhahran (SA)

(72) Inventors: Chao Liu, Brookshire, TX (US); Dung Phan, Houston, TX (US); Younane N. Abousleiman, Norman, OK (US)

(21) Appl. No.: 16/896,757

(22) Filed: Jun. 9, 2020

(51) Int. Cl. G01V 99/00; E21B 47/00

(52) U.S. Cl. CPC G01V 99/005; G01V 2210/646; G01V 2210/1234; E21B 47/00

(57) ABSTRACT

The subject matter of this specification can be embodied in, among other things, a method for determining leak-off rate includes receiving a collection of geological data descriptive of a well path through a predetermined geographical area, the geological data comprising fracture density and fracture distribution data obtained from offset wellbore image and wellbore nuclear magnetic resonance logs, determining a hydraulic fracturing fluid leak-off rate based on the received collection of geological data, and providing the determined hydraulic fracturing fluid leak-off rate.

### TECHNICAL FIELD

The present disclosure applies to hydraulic fracturing for hydrocarbon production operations.

### BACKGROUND

Hydraulic fracturing is used for the extraction of hydrocarbon from unconventional low-permeability rock formations. In some hydraulic fracturing operations, over 80% of fracturing fluid leaks into rock formation and only less than 20% is flowed back. As unconventional rock matrix has ultra-low permeability, this large amount of hydraulic fracturing fluid loss is mainly due to the various densities of fractures in size or openings which are natural and created by hydraulic fracturing process zones. Such fractures usually have much larger permeability than source shale matrix and therefore play the major role in fluid losses or fluid leak-off. Conventional leak-off calculations, such as Carter's formula, do not consider such highly permeable fractures and therefore could be erroneous. Since leak-off is an essential component when simulating and planning hydraulic fracture field operations, estimates of leak-off rates can be inaccurate and can lead to poor hydraulic fracturing design and performance.

### SUMMARY

In some implementations, a computer-implemented method includes the following.

In an example aspect, a method for determining leak-off rate includes receiving a collection of geological data descriptive of a well path through a predetermined geographical area, the geological data comprising fracture density and fracture distribution data obtained from offset wellbore image and wellbore nuclear magnetic resonance logs, determining a hydraulic fracturing fluid leak-off rate based on the received collection of geological data, and providing the determined hydraulic fracturing fluid leak-off rate.

Various implementations can include some, all, or none of the following features. The method can also include determining an amount of hydraulic fracturing fluid based on the provided hydraulic fracturing fluid leak-off rate, and providing the determined amount of hydraulic fracturing fluid to the predetermined geographical area. The hydraulic fracturing fluid leak-off rate can be further based on an N-porosity N-permeability media model. The hydraulic fracturing fluid leak-off rate can be further based on an average leak-off velocity value. The average leak-off velocity value can be given by the equation: q=Σᵢ₌₁^{N}vᵢqᵢ, where:

$${q}_{i} ( t ) = - \frac{{k}_{i}}{μ} \frac{\partial {p}_{i}}{\partial x} ( x = 0 , t ) = - \frac{2}{L} {\sum }_{m = 0}^{∞} \frac{{k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{ρ {C}_{v}} \frac{{( 2 m + 1 )}^{2} {π}^{2}}{4 {b}^{2}} t} ) cos \frac{( 2 m + 1 ) π}{2 b} .$$

The hydraulic fracturing fluid leak-off rate can be given by the equation: Q=2qΣⱼ₌₁ⁿhⱼlⱼ. The hydraulic fracturing fluid leak-off rate can be given by the equation:

$$Q = - \frac{4}{L} {\sum }_{j = 1}^{n} {\sum }_{i = 1}^{N} {\sum }_{m = 0}^{∞} \frac{{h}_{j} {l}_{j} {v}_{i} {k}_{i}}{μ} \frac{( 2 m + ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{ρ {C}_{v}} \frac{{( 2 m + 1 )}^{2} {π}^{2}}{4 {b}^{2}} t} ) cos \frac{( 2 m + 1 ) π}{2 b} .$$

The method can also include receiving permeability data descriptive of the well path, and determining the collection of geological data based on the permeability data.

In another example aspect, a computer-implemented system includes one or more processors, and a non-transitory computer-readable storage medium coupled to the one or more processors and storing programming instructions for execution by the one or more processors, the programming instructions instructing the one or more processors to perform operations including receiving a collection of geological data descriptive of a well path through a predetermined geographical area, the geological data including fracture density and fracture distribution data obtained from offset wellbore image and wellbore nuclear magnetic resonance logs, determining a hydraulic fracturing fluid leak-off rate based on the received collection of geological data, and providing the determined hydraulic fracturing fluid leak-off rate.

Various embodiments can include some, all, or none of the following features. The system can also include determining an amount of hydraulic fracturing fluid based on the provided hydraulic fracturing fluid leak-off rate, controlling, based on the determined amount, an actuator, and providing, based on the controlling, the determined amount of hydraulic fracturing fluid to the predetermined geographical area. The hydraulic fracturing fluid leak-off rate can be further based on an N-porosity N-permeability media model. The hydraulic fracturing fluid leak-off rate can be further based on an average leak-off velocity value. The average leak-off velocity value can be given by the equation:

$$q = {\sum }_{i = 1}^{N} {v}_{i} {q}_{i} where {q}_{i} ( t ) = - \frac{{k}_{i}}{μ} \frac{\partial {p}_{i}}{\partial x} ( x = 0 , t ) = - \frac{2}{L} {\sum }_{m = 0}^{∞} \frac{{k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{ρ {C}_{v}} \frac{{( 2 m + 1 )}^{2} {π}^{2}}{4 {b}^{2}} t} ) cos \frac{( 2 m + 1 ) π}{2 b} .$$

The hydraulic fracturing fluid leak-off rate can be given by the equation: Q=2qΣⱼ₌₁ⁿhⱼlⱼ. The hydraulic fracturing fluid leak-off rate can be given by the equation:

$$= - \frac{4}{L} {\sum }_{j = 1}^{n} {\sum }_{i = 1}^{N} {\sum }_{m = 0}^{∞} \frac{{h}_{j} {l}_{j} {v}_{i} {k}_{i}}{μ} \frac{( 2 m + ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{ρ {C}_{v}} \frac{{( 2 m + 1 )}^{2} {π}^{2}}{4 {b}^{2}} t} ) cos \frac{( 2 m + 1 ) π}{2 b} .$$

The operations can also include receiving permeability data descriptive of the well path, and determining the collection of geological data based on the permeability data.

In another example aspect, a non-transitory, computer-readable medium storing one or more instructions executable by a computer system to perform operations includes receiving a collection of geological data descriptive of a well path through a predetermined geographical area, the geological data comprising fracture density and fracture distribution data obtained from offset wellbore image and wellbore nuclear magnetic resonance logs, determining a hydraulic fracturing fluid leak-off rate based on the received collection of geological data, and providing the determined hydraulic fracturing fluid leak-off rate.

Various embodiments can include some, all, or none of the following features. The operations can also include determining an amount of hydraulic fracturing fluid based on the provided hydraulic fracturing fluid leak-off rate, and providing the determined amount of hydraulic fracturing fluid to the predetermined geographical area. The hydraulic fracturing fluid leak-off rate can be further based on an N-porosity N-permeability media model. The hydraulic fracturing fluid leak-off rate can be further based on an average leak-off velocity value.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, a model can be implemented to represent rock matrices having micro fractures and macro fractures. Second, the model can represent hydraulic fracturing fluid leak-off behavior in such rock matrices under various predetermined temperatures. Third, the leak-off rates can be more accurately estimated. Fourth, hydrocarbon job site planning can be improved based on the estimated leak-off rates. Fifth, hydrocarbon fracturing fluid use can be improved based on the estimated leak-off rates.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a conceptual sectional view of an example of a work zone for multi-stage hydraulic fracturing, according to some implementations of the present disclosure.

FIG. 2 is conceptual section view of an example one-dimensional consolidation problem, according to some implementations of the present disclosure.

FIG. 3 is a chart that shows an example evolution of leak-off rate in rock matrix, micro fractures, and macro fractures, according to some implementations of the present disclosure.

FIG. 4 is a flow diagram of an example process for multi-stage hydraulic fracturing, according to some implementations of the present disclosure.

FIG. 5 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for estimating hydraulic fracturing fluid leak-off in multi-stage hydraulic fracturing. In some implementations, the estimated leak-off rates can be used to estimate or predict fracture geometries and the amounts fracturing fluid that can be used. For example, for a given fixed amount of fracturing fluid and leak-off rate, the fracture geometry (including fracture length) can be estimated. Given a desired fracture length and the leak-off rate, an amount of fluid needed to achieve the target fracture length can be determined. In some implementations, the estimated leak-off rates can help improve the design of hydraulic fracturing jobs.

Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

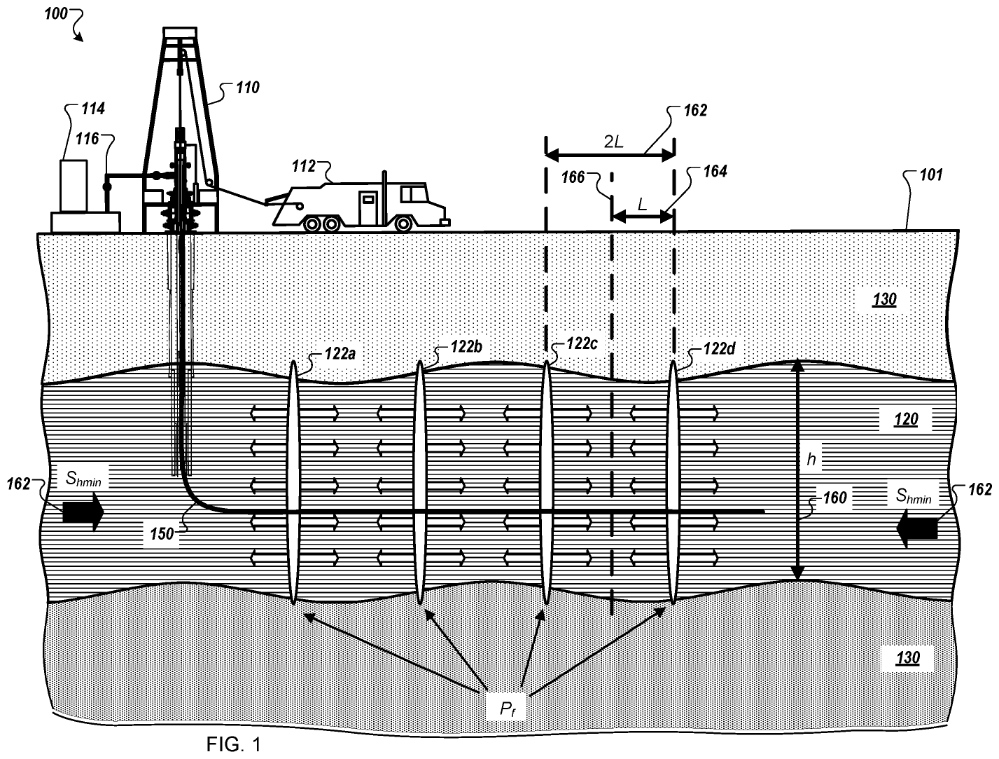

FIG. 1 is a conceptual sectional view of an example of a work zone. The work zone 100 extends across a portion of the Earth's surface 101. At the surface 101, surface activities occur, such as the construction and operation of a drilling rig 110 or related equipment, the use of vehicular equipment 112, and wellsite monitoring and modelling by a processing system 114. Below the surface 101 are a shale formation 120 and various layers 130 of rock, soil, sand, and other geological materials. The shale formation 120 includes a collection of fractures 122a-122d. The properties of the shale formation 120 can be measured or observed (e.g., well tests and well logs, such as acoustic, resistivity, density, porosity, and nuclear magnetic resonance logs), and provided to the processing system 114 to determine leak-off rates and other information that can be used in well site operations. The processing system 114 is configured determine a hydraulic fracturing fluid leak-off rate based on the provided data, and adjust an actuator 116 (e.g., valve, pump) to provide an amount of hydraulic fracturing fluid downhole based on the determined amount.

In the illustrated example, a multi-stage hydraulic fracturing design for a horizontal wellbore 150 in the shale formation 120 is shown. The shale formation has a thickness of h as represented by arrow 160. In the illustrated example, the horizontal wellbore 150 is drilled along the direction of minimal horizontal stress Sₕₘᵢₙ, represented by arrows 162.

Considering two neighboring hydraulic fractures 122c and 122d, the fracture spacing is 2 L, as represented by arrow 162. Both of the fractures 122c and 122d are equally spaced at a distance L, represented by arrow 164, from a symmetric axis 166 defined by the midpoint of the fracture spacing 162.

Field observations and scanning electron microscopic examinations of source shale have shown that such fractures exist at various scales such as macro-scale, micro-scale, and nano-scale. That means source shale has more than two porous components. Such multi-porous components can naturally contribute to flow correlated to multi-permeability systems, and to unexpected leak-off estimates. Under such conditions, field-applied high-pressure fluid for fracturing will not only propagate the hydraulic fractures in length and width, but can also force the leak into the fracture faces of the formations through such multi-permeability channels. The estimation of leak-off in hydraulic fracturing design could be highly inaccurate the varying fluid flow rates in multi-permeability channels through the hydraulic fracture faces is not accounted for. The techniques that account for such permeabilities in estimations of leak-off rates is discussed in paragraphs that follow.

Thermal effects can also play influential roles in fluid losses. In some examples, temperature differences between the fracturing fluid and the rock formation can lead to thermal diffusion in the rock formation near the hydraulic fracture faces. The temperature variation in a rock formation can result in contraction or expansion, and can cause variations of pore pressures, and the gradients of such pore pressures at hydraulic fracture faces can affect the fracturing fluid leak-off rate. Temperature can also affect fluid viscosity, therefore also affecting the leak-off rate. The techniques that are discussed in paragraphs that follow can estimate the effects of temperature.

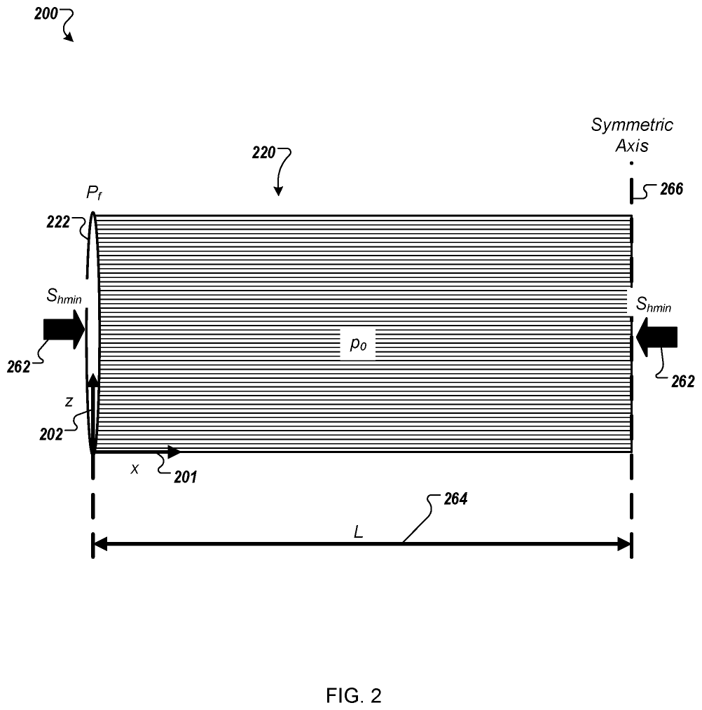

FIG. 2 is conceptual section view 200 of an example one-dimensional consolidation problem, according to some implementations of the present disclosure. The view 200 shows a subsection 220 of a shale formation in a plane defined by an x axis 201 and a z axis 202. The x axis 201 is aligned with the direction of minimal horizontal stress Sₕₘᵢₙ, represented by arrows 262. In some implementations, the subsection 220 can be a subsection of the example shale formation 120 of FIG. 1.

The view 200 illustrates a fracture 222 (Pr) that is a distance L, represented by arrow 264, away from a symmetric axis 266 across the subsection 220. The subsection 220 has a pore pressure (p) p₀. In general, FIG. 2 is provided as a visual reference for the processes and mathematical models that will be discussed in subsequent paragraphs.

In order to estimate hydraulic fracturing leak-off rates, a model featuring N-porosity N-permeability coupled with temperature will be described. In some implementations, the determined values of leak-off rates can be further employed in hydraulic fracturing design for estimating hydraulic fracture dimensions and amounts of fracturing fluid that can be used.

The technique originates from a collection of poroelastic governing equations with temperature coupled for single-porosity anisotropic materials. For isotropic porous materials, the governing equations can be expressed as follows.

$$\begin{matrix}- {β T}_{0} \frac{{\partial }^{2} u}{\partial x \partial t} + {ρ C}_{v} \frac{\partial T}{\partial t} - λ \frac{{\partial }^{2} T}{\partial {x}^{2}} = 0 & ( Equation 1 ) \\ \frac{3 K ( 1 - v )}{1 + v} \frac{{\partial }^{2} u}{\partial {x}^{2}} + α \frac{\partial p}{\partial x} + β \frac{\partial T}{\partial x} = 0 & ( Equation 2 ) \\ \frac{k}{μ} \frac{{\partial }^{2} p}{\partial {x}^{2}} - \frac{1}{M} \frac{\partial p}{\partial t} + α \frac{{\partial }^{2} u}{\partial x \partial t} + β \frac{\partial T}{\partial t} = 0 & ( Equation 3 )\end{matrix}$$

Where β is the thermal coefficient, T₀ is the initial temperature, u is the displacement, x is the direction perpendicular to the fracture face and going into the formation, t is time, ρ is the bulk density, Cᵥ is the thermal capacity, T is the temperature, λ is the thermal conductivity, K is the bulk modulus, v is the Poisson's ratio, α is the Biot coefficient, k is the permeability, μ is the fracturing fluid viscosity, p is the pore pressure, M is the Biot modulus.

The above single-porosity model can be generalized to N-porosity N-permeability media. The new model works by overlapping N porous media, where each porous medium has its own hydro-mechanical properties and pore pressure field. The equations that describe an N-porosity N-permeability porous medium are expressed as follows:

$$\begin{matrix} - {β T}_{0} \frac{{\partial }^{2} u}{\partial x \partial t} + {ρ C}_{v} \frac{\partial T}{\partial t} - λ \frac{{\partial }^{2} T}{\partial {x}^{2}} = 0 & ( Equation 4 ) \\ \frac{3 K ( 1 - v )}{1 + v} \frac{{\partial }^{2} u}{\partial {x}^{2}} + {\sum }_{j = 1}^{N} {α}_{j} \frac{\partial {p}_{j}}{\partial x} + β \frac{\partial T}{\partial x} = 0 & ( Equation 5 ) \\ \frac{{k}_{i}}{μ} \frac{{\partial }^{2} {p}_{i}}{\partial {x}^{2}} - {\sum }_{j = 1}^{N} \frac{1}{{M}_{ij}} \frac{\partial {p}_{j}}{\partial t} + {α}_{i} \frac{{\partial }^{2} u}{\partial x \partial t} + β \frac{\partial T}{\partial t} + {\sum }_{j = 1}^{N} {Γ}_{ij} ( {p}_{j} - {p}_{i} ) = 0 , i = 1 , 2 , ⋯ , N & ( Equation 6 )\end{matrix}$$

Where αⱼ is the Biot coefficient of porous medium j, pⱼ is the pore pressure in porous medium j, kᵢ is the permeability of porous medium i, Mᵢⱼ is the effective coupled Biot's modulus, Γᵢⱼ is the inter-porosity flow coefficient between porous media i and j.

The initial conditions for the one-dimensional consolidation problem are given as follows.

At t=0:

p=p₀ (Equation 7)

σₓₓ=Sₕₘᵢₙ (Equation 8)

u=0 (Equation 9)

T=T₀ (Equation 10)

Where T₀ is the formation's initial temperature.

The boundary conditions for the one-dimensional consolidation problem can be represented as follows.

$$\begin{matrix}At x = 0 : & \\ {p}_{1} = {p}_{2} = ⋯ = {p}_{N} = {P}_{f} & ( Equation 11 ) \\ {σ}_{xx} = {P}_{f} & ( Equation 12 ) \\ T = {T}_{f} & ( Equation 13 ) \\ At x = L : & \\ \frac{\partial {p}_{1}}{\partial x} = \frac{\partial {p}_{2}}{\partial x} = ⋯ = \frac{\partial {p}_{N}}{\partial x} = 0 & ( Equation 14 ) \\ \frac{\partial u}{\partial x} = 0 & ( Equation 15 ) \\ \frac{\partial T}{\partial x} = 0 & ( Equation 16 )\end{matrix}$$

Where P_{f} and T_{f} represent fracturing fluid pressure and temperature.

The governing equations (4-6) are solved with initial conditions (7-10) and boundary conditions (11-16), and obtain the solutions of N pore pressure fields as follows.

$${p}_{i} = \frac{2}{L} {\sum }_{m = 0}^{∞} ( {C}_{im} {e}^{{γ}_{m} t} - \frac{2 {LD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {L}^{2}} t} ) sin \frac{( 2 m + 1 ) π}{2 L} + {P}_{f} , i = 1 , 2 , ⋯ , N \qquad ( Equation 17 )$$

Where Cᵢₘ, γₘ, and Dᵢ are solution coefficients which can be determined by submitting (17) to (7-10) and (11-16).

The velocity of leak-off into each individual porous medium can be calculated using the following equation:

$${q}_{i} ( t ) = - \frac{{k}_{i}}{μ} \frac{\partial {p}_{i}}{\partial x} ( x = 0 , t ) = - \frac{2}{L} {\sum }_{m = 0}^{∞} \frac{{k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} \qquad ( Equation 18 )$$

And the average leak-off velocity (m/s) into the rock formation can be represented by the arithmetic average of the N leak-off velocities, for example:

q=Σᵢ₌₁^{N}vᵢqᵢ (Equation 19)

Where vᵢ is the volume fraction of each individual porous medium.

The average leak-off velocity (m/s) is derived as follows:

$$q = - \frac{2}{L} {\sum }_{i = 1}^{N} {\sum }_{m = 0}^{∞} \frac{{v}_{i} {k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} \qquad ( Equation 20 )$$

Suppose there are n stages of hydraulic fractures where stage j has a height of hᵢ and a length of lⱼ. The total leak-off rate Q (m³/s) can be calculated using the following equation:

$$Q = 2 q {\sum }_{j = 1}^{n} {h}_{j} {l}_{j} = - \frac{4}{L} {\sum }_{j = 1}^{n} {\sum }_{i = 1}^{N} {\sum }_{m = 0}^{∞} \frac{{h}_{j} {l}_{j} {v}_{i} {k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} \qquad ( Equation 21 )$$

### Numerical Example

In this section, an example of triple-porosity triple-permeability (N=3) is used to illustrate the estimation of fracturing fluid leak-off rate using the described model. The triple-porosity triple-permeability rock properties are listed in Table 1. These properties can be derived from well tests and well logs such as acoustic, resistivity, density, porosity, and nuclear magnetic resonance (NMR) logs.

TABLE 1
Example triple-porosity triple-permeability rock properties.

| | Rock | Micro- | Macro- |
|---|---|---|---|
| Properties | Matrix | Fractures | Fractures |
| Bulk modulus, K (GPa) | 10 | 1.5 | 0.75 |
| Poisson's ratio, v | 0.3 | 0.3 | 0.3 |
| Biot's coefficient, α | 0.6 | 1.0 | 1.0 |
| Biot's modulus, M (GPa) | 14.8 | 2.4 | 2.4 |
| Permeability, k (nD) | 45 | 45 × 10³ | 90 × 10³ |
| Fluid viscosity, μ (Pa · s) | 0.001 | 0.001 | 0.001 |
| Volume fraction, v | 0.97 | 0.02 | 0.01 |

| | |
|---|---|
| Inter-Porosity Flow Coefficient, | 5.0 |
| Γ₁₂ (GPa⁻¹day⁻¹) | |
| Inter-Porosity Flow Coefficient, | 6.0 |
| Γ₁₃ (GPa⁻¹day⁻¹) | |
| Inter-Porosity Flow Coefficient, | 10.0 |
| Γ₂₃ (GPa⁻¹day⁻¹) | |
| Thermal conductivity, λ/ρCᵥ (m²/s) | 5.4 × 10⁻⁷ |

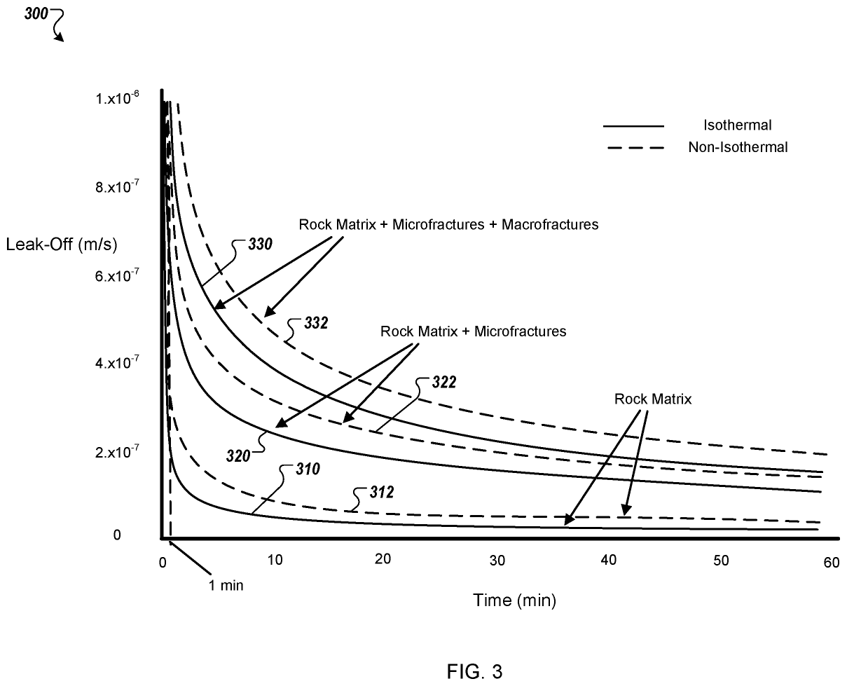

FIG. 3 is a chart 300 that shows an example evolution of leak-off rate in rock matrix, micro fractures, and macro fractures, according to some implementations of the present disclosure. The chart 300 shows example leak-off rates for isothermal and non-isothermal cases. For the non-isothermal cases, fracturing fluid is 60° C. cooler than formation.

The chart 300 shows an example isothermal leak-off rate 310 and an example non-isothermal leak-off rate 312 for a rock matrix alone. The chart 300 also shows an example isothermal leak-off rate 320 and an example non-isothermal leak-off rate 322 for the rock matrix and micro fractures in the rock matrix. The chart 300 also shows an example isothermal leak-off rate 330 and an example non-isothermal leak-off rate 332 for the rock matrix, the micro fractures, and macro fractures in the rock matrix. The thermal effect on leak-off rate can be quantified by the leak-off equation (equation 21), and is significant in the illustrated example. The example triple-porosity triple-permeability effects on leak-off rate can also be quantified in the leak-off equation.

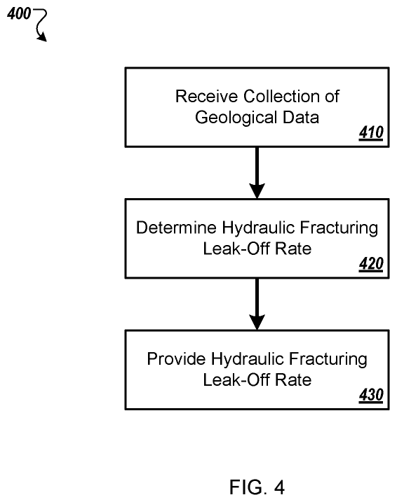

FIG. 4 is a flowchart of an example process 400 for multi-stage hydraulic fracturing, according to some implementations of the present disclosure. For clarity of presentation, the description that follows generally describes process 400 in the context of the other figures in this description. However, it will be understood that process 400 can be performed, for example, by any suitable system, environment, software, and hardware, or a combination of systems, environments, software, and hardware, as appropriate. In some implementations, various steps of process 400 can be run in parallel, in combination, in loops, or in any order.

At 410, a collection of geological data descriptive of a well path through a predetermined geographical area is received. The geological data includes fracture density and fracture distribution data obtained from offset wellbore image and wellbore nuclear magnetic resonance logs. For example, the example processing system 114 of FIG. 1 can receive well test and well log data about the shale formation 120.

From 410, process 400 proceeds to 420.

At 420, a hydraulic fracturing fluid leak-off rate is determined based on the received data. For example, the processing system 114 can determine a hydraulic fracturing fluid leak-off rate.

In some implementations, the hydraulic fracturing fluid leak-off rate can be further based on an N-porosity N-permeability media model. For example, the processing system 114 can determine the leak-off rate for formations that have multiple (e.g., N) porosities and multiple (e.g., N) permeabilities.

In some implementations, the hydraulic fracturing fluid leak-off rate can be further based on an average leak-off velocity value. In some implementations, the average leak-off velocity value can be given by Equation 19, where qi can be given by Equation 18. In some implementations, the hydraulic fracturing fluid leak-off rate can be given by Equation 21.

From 420, process 400 proceeds to 430.

At 430, the determined hydraulic fracturing fluid leak-off rate is provided. For example, the example processing system 114 can provide the determined leak-off rate to a user or to another system or controller for further analysis or use.

In some implementations, the process 400 can also include determining an amount of hydraulic fracturing fluid based on the provided hydraulic fracturing fluid leak-off rate, and providing the determined amount of hydraulic fracturing fluid to the predetermined geographical area. For example the example processing system 114 can use the determined leak-off rate to adjust the actuator 116 modify an amount of hydraulic fracturing fluid provided to the shale formation 120.

In some implementations, the process 400 can also include receiving permeability data descriptive of the well path, and determining the collection of geological data based on the permeability data. For example, the example processing system 114 can receive well test and well log data collected along the horizontal wellbore 150.

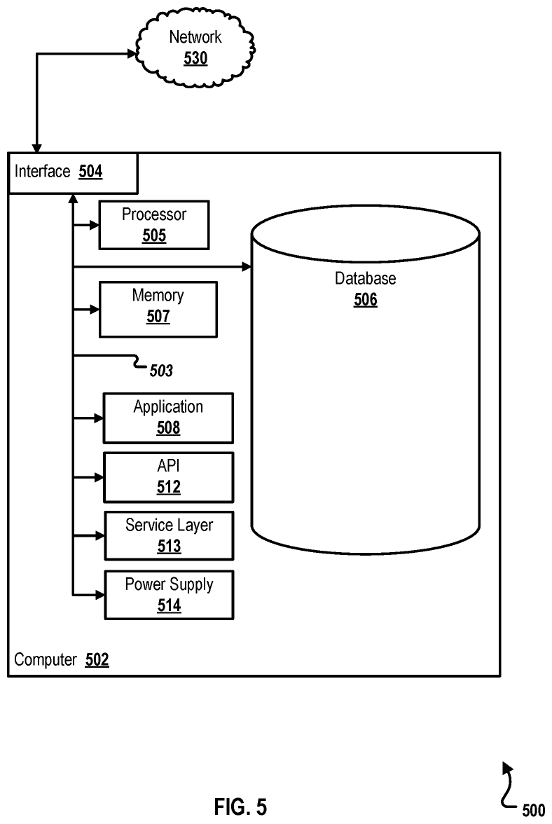

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Described implementations of the subject matter can include one or more features, alone or in combination.

For example, in a first implementation, a method for determining leak-off rate includes receiving a collection of geological data descriptive of a well path through a predetermined geographical area, the geological data comprising fracture density and fracture distribution data obtained from offset wellbore image and wellbore nuclear magnetic resonance logs, determining a hydraulic fracturing fluid leak-off rate based on the received collection of geological data, and providing the determined hydraulic fracturing fluid leak-off rate.

The foregoing and other described implementations can each, optionally, include one or more of the following features:

A first feature, combinable with any of the following features, the method further including: determining an amount of hydraulic fracturing fluid based on the provided hydraulic fracturing fluid leak-off rate, and providing the determined amount of hydraulic fracturing fluid to the predetermined geographical area.

A second feature, combinable with any of the previous or following features, where the hydraulic fracturing fluid leak-off rate can be further based on an N-porosity N-permeability media model.

A third feature, combinable with any of the previous or following features, where hydraulic fracturing fluid leak-off rate can be further based on an average leak-off velocity value. The average leak-off velocity value can be given by the equation: q=Σᵢ₌₁^{N}vᵢqᵢ, where:

$${q}_{i} ( t ) = - \frac{{k}_{i}}{μ} \frac{\partial {p}_{i}}{\partial x} ( x = 0 , t ) = - \frac{2}{L} {\sum }_{m = 0}^{∞} \frac{{k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} .$$

A fourth feature, combinable with any of the previous or following features, where the hydraulic fracturing fluid leak-off rate can be given by the equation: Q=2qΣⱼ₌₁ⁿhⱼlⱼ.

A fifth feature, combinable with any of the previous or following features, where hydraulic fracturing fluid leak-off rate can be given by the equation:

$$Q = - \frac{4}{L} {\sum }_{j = 1}^{n} {\sum }_{i = 1}^{N} {\sum }_{m = 0}^{∞} \frac{{h}_{j} {l}_{j} {v}_{i} {k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} .$$

A sixth feature, combinable with any of the previous or following features, where the method can also include receiving permeability data descriptive of the well path, and determining the collection of geological data based on the permeability data.

In a second implementation, a computer-implemented system includes one or more processors, and a non-transitory computer-readable storage medium coupled to the one or more processors and storing programming instructions for execution by the one or more processors, the programming instructions instructing the one or more processors to perform operations including receiving a collection of geological data descriptive of a well path through a predetermined geographical area, the geological data including fracture density and fracture distribution data obtained from offset wellbore image and wellbore nuclear magnetic resonance logs, determining a hydraulic fracturing fluid leak-off rate based on the received collection of geological data, and providing the determined hydraulic fracturing fluid leak-off rate.

The foregoing and other described implementations can each, optionally, include one or more of the following features:

In a first feature, combinable with any of the following features, the system can also include determining an amount of hydraulic fracturing fluid based on the provided hydraulic fracturing fluid leak-off rate, controlling, based on the determined amount, an actuator, and providing, based on the controlling, the determined amount of hydraulic fracturing fluid to the predetermined geographical area.

A second feature, combinable with any of the previous or following features, where the hydraulic fracturing fluid leak-off rate can be further based on an N-porosity N-permeability media model. The hydraulic fracturing fluid leak-off rate can be further based on an average leak-off velocity value. The average leak-off velocity value can be given by the equation: q=Σᵢ₌₁^{N}vᵢqᵢ where

$${q}_{i} ( t ) = - \frac{{k}_{i}}{μ} \frac{\partial {p}_{i}}{\partial x} ( x = 0 , t ) = - \frac{2}{L} {\sum }_{m = 0}^{∞} \frac{{k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} .$$

A third feature, combinable with any of the previous or following features, where the hydraulic fracturing fluid leak-off rate can be given by the equation: Q=2qΣⱼ₌₁ⁿhⱼlⱼ.

A fourth feature, combinable with any of the previous or following features, where the hydraulic fracturing fluid leak-off rate can be given by the equation:

$$Q = - \frac{4}{L} {\sum }_{j = 1}^{n} {\sum }_{i = 1}^{N} {\sum }_{m = 0}^{∞} \frac{{h}_{j} {l}_{j} {v}_{i} {k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} .$$

A fifth feature, combinable with any of the previous or following features, where the operations can also include receiving permeability data descriptive of the well path, and determining the collection of geological data based on the permeability data.

In a third implementation, a computer-implemented system, including one or more processors and a non-transitory, computer-readable medium storing one or more instructions executable by a computer system to perform operations includes receiving a collection of geological data descriptive of a well path through a predetermined geographical area, the geological data comprising fracture density and fracture distribution data obtained from offset wellbore image and wellbore nuclear magnetic resonance logs, determining a hydraulic fracturing fluid leak-off rate based on the received collection of geological data, and providing the determined hydraulic fracturing fluid leak-off rate.

The foregoing and other described implementations can each, optionally, include one or more of the following features:

A first feature, combinable with any of the following features, where the operations can also include determining an amount of hydraulic fracturing fluid based on the provided hydraulic fracturing fluid leak-off rate, and providing the determined amount of hydraulic fracturing fluid to the predetermined geographical area.

A second feature, combinable with any of the previous or following features, where the hydraulic fracturing fluid leak-off rate is further based on an N-porosity N-permeability media model.

A third feature, combinable with any of the previous or following features, where the hydraulic fracturing fluid leak-off rate is further based on an average leak-off velocity value.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A method for determining leak-off rate, comprising:
receiving a collection of geological data descriptive of a well path through a predetermined geographical area, the geological data comprising fracture density and fracture distribution data obtained from offset wellbore image and wellbore nuclear magnetic resonance logs;
determining a hydraulic fracturing fluid leak-off rate based on the received collection of geological data; and
providing the determined hydraulic fracturing fluid leak-off rate.

2. The method of claim 1, further comprising:
determining an amount of hydraulic fracturing fluid based on the provided hydraulic fracturing fluid leak-off rate; and
providing the determined amount of hydraulic fracturing fluid to the predetermined geographical area.

3. The method of claim 1, wherein the hydraulic fracturing fluid leak-off rate is further based on an N-porosity N-permeability media model.

4. The method of claim 1, wherein the hydraulic fracturing fluid leak-off rate is further based on an average leak-off velocity value.

5. The method of claim 4, wherein the average leak-off velocity value is given by the equation:
q=Σᵢ₌₁^{N}vᵢqᵢ,
where:
$${q}_{i} ( t ) = - \frac{{k}_{i}}{μ} \frac{\partial {p}_{i}}{\partial x} ( x = 0 , t ) = - \frac{2}{L} {\sum }_{m = 0}^{∞} \frac{{k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} .$$

6. The method of claim 1, wherein the hydraulic fracturing fluid leak-off rate is given by the equation:
Q=2qΣⱼ₌₁ⁿhⱼlⱼ.

7. The method of claim 1, wherein the hydraulic fracturing fluid leak-off rate is given by the equation:
$$Q = - \frac{4}{L} {\sum }_{j = 1}^{n} {\sum }_{i = 1}^{N} {\sum }_{m = 0}^{∞} \frac{{h}_{j} {l}_{j} {v}_{i} {k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} .$$

8. The method of claim 1, further comprising:
receiving permeability data descriptive of the well path; and
determining the collection of geological data based on the permeability data.

9. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving a collection of geological data descriptive of a well path through a predetermined geographical area, the geological data comprising fracture density and fracture distribution data obtained from offset wellbore image and wellbore nuclear magnetic resonance logs;
determining a hydraulic fracturing fluid leak-off rate based on the received collection of geological data; and
providing the determined hydraulic fracturing fluid leak-off rate.

10. The system of claim 9, the operations further comprising:
determining an amount of hydraulic fracturing fluid based on the provided hydraulic fracturing fluid leak-off rate;
controlling, based on the determined amount, an actuator; and
providing, based on the controlling, the determined amount of hydraulic fracturing fluid to the predetermined geographical area.

11. The system of claim 9, wherein the hydraulic fracturing fluid leak-off rate is further based on an N-porosity N-permeability media model.

12. The system of claim 9, wherein the hydraulic fracturing fluid leak-off rate is further based on an average leak-off velocity value.

13. The system of claim 12, wherein the average leak-off velocity value is given by the equation:
q=Σᵢ₌₁^{N}vᵢqᵢ,
where:
$${q}_{i} ( t ) = - \frac{{k}_{i}}{μ} \frac{\partial {p}_{i}}{\partial x} ( x = 0 , t ) = - \frac{2}{L} {\sum }_{m = 0}^{∞} \frac{{k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} .$$

14. The system of claim 9, wherein the hydraulic fracturing fluid leak-off rate is given by the equation:
Q=2qΣⱼ₌₁ⁿhⱼlⱼ.

15. The system of claim 9, wherein the hydraulic fracturing fluid leak-off rate is given by the equation:
$$Q = - \frac{4}{L} {\sum }_{j = 1}^{n} {\sum }_{i = 1}^{N} {\sum }_{m = 0}^{∞} \frac{{h}_{j} {l}_{j} {v}_{i} {k}_{i}}{μ} \frac{( 2 m + 1 ) π}{2 b} ( {C}_{im} {e}^{{γ}_{m} t} - \frac{2 {bD}_{i} ( {T}_{f} - {T}_{0} )}{( 2 m + 1 ) π} {e}^{- \frac{λ}{{ρ C}_{v}} \frac{{( 2 m + 1 )}^{2} {π}^{2}}{4 {b}^{2}} t} ) cos \frac{( 2 m + 1 ) π}{2 b} .$$

16. The system of claim 9, the operations further comprising:
receiving permeability data descriptive of the well path; and
determining the collection of geological data based on the permeability data.

17. A non-transitory, computer-readable medium storing one or more instructions executable by a computer system to perform operations comprising:
receiving a collection of geological data descriptive of a well path through a predetermined geographical area, the geological data comprising fracture density and fracture distribution data obtained from offset wellbore image and wellbore nuclear magnetic resonance logs;
determining a hydraulic fracturing fluid leak-off rate based on the received collection of geological data; and
providing the determined hydraulic fracturing fluid leak-off rate.

18. The system of claim 9, the operations further comprising:
determining an amount of hydraulic fracturing fluid based on the provided hydraulic fracturing fluid leak-off rate; and
providing the determined amount of hydraulic fracturing fluid to the predetermined geographical area.

19. The system of claim 9, wherein the hydraulic fracturing fluid leak-off rate is further based on an N-porosity N-permeability media model.

20. The system of claim 9, wherein the hydraulic fracturing fluid leak-off rate is further based on an average leak-off velocity value.
